(19) United States
(12) Patent Application Publication
(10) Pub. No.: US 2004/0223409 A1
(43) Pub. Date: Nov. 11, 2004

(54) Bread maker and control method thereof

(75) Inventors: Jae-ryong Park, Suwon-city (KR); Yong-hyun Kwon, Suwon-city (KR); Chul Kim, Anyang-city (KR); Tae-uk Lee, Suwon-city (KR); Han-jun Sung, Suwon-city (KR); Jang-woo Lee, Suwon-city (KR); Dong-bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/805,198

(22) Filed: Mar. 22, 2004

(30) Foreign Application Priority Data
May 7, 2003 (KR) 2003-29064

(51) Int. Cl. A23G 3/10

(52) U.S. Cl. 366/348

(57) ABSTRACT

A bread maker to perform a bread making process including a main body forming an oven compartment; upper and lower kneading drums spaced apart from each other inside the oven compartment, each kneading drum having a holding part holding opposite ends of a mixing bag filled with dough; a drum driving part rotating the kneading drums in clockwise and counterclockwise directions to knead the dough contained in the mixing bag; an auxiliary power supply to supply power when power supply of a primary power supply is cut off; a rotation sensing part sensing rotation position of the kneading drums; and a controller which receives power from the auxiliary power supply, measures a time interval from interruption to resumption of the power supply, determines whether the measured time exceeds a predetermined limit of power-interruption time, and ends the bread making process when the measured time exceeds the predetermined limit of power-interruption time. Thus, when power supply is resumed after the power-interruption time excessively passes, the bread making process is ended, and the mixing bag is easily removed.

### CROSS-REFERENCE TO RELATED APPLICATIONS

This application claims the benefit of Korean Application No. 2003-29064, filed May 7, 2003, in the Korean Intellectual Property Office, the disclosure of which is incorporated herein by reference.

### BACKGROUND OF THE INVENTION

1. Field of the Invention

The present invention relates to a bread maker for automatically making bread and a control method thereof.

2. Description of the Related Art

Generally, making bread is so complicated that it is difficult for average persons to make good bread at home by hand. This is because the process of making bread includes multiple steps of mixing ingredients such as flour, sugar, yeast, etc., to form a dough; kneading the dough; leavening the dough; baking the dough; and so on.

Therefore, various bread makers have been developed to allow a user to easily make bread by automatically performing the foregoing multiple steps to provide finished bread to the user.

For example, a bread maker disclosed in Korean Patent Publication No. 1991-10203 includes a pair of parallel kneading drums at upper and lower parts of an oven compartment that reverse rotary direction periodically, a baking tray between the pair of kneading drums, heaters to heat the inside of the oven compartment, a bar code scanner, etc.

In the bread maker according to Korean Patent Publication No. 1991-10203, upper and lower ends of a mixing bag filled with flour, water, etc., are attached to the upper and lower kneading drums, and then the mixing bag is reciprocated up and down for a predetermined time, thereby kneading the dough in the mixing bag.

After completing the kneading of the dough, the mixing bag is automatically separated from the upper kneading drum, and is completely wound on the lower kneading drum, with the dough being squeezed out of the mixing bag into the baking tray. Thereafter, the heaters heat the inside of the oven compartment, thereby leavening and baking the dough for a predetermined time.

The process of making the bread depends on reading a bar code that is printed on the mixing bag. The bar code contains information on kneading time, leavening time, baking time, etc., according to a specific recipe. The bar code is read by a bar code scanner and the read data are transmitted to a controller that controls the kneading drums, the heaters, etc., on the basis of the read data.

However, power supplied to the bread maker may be abruptly cut off owing to a user's carelessness or interruption of electric power.

In this case, a conventional bread maker continues the interrupted bread-making process if power supply to the bread maker is resumed after the interruption of the electric power, or ends the bread making process at the same time when the interruption of the electric power happens.

According to the conventional bread maker which continues the bread making process if power supply to the bread maker is resumed after the interruption of the electric power, when power supply is resumed after the power-interruption time excessively passes, bread having a desired quality may not be made since an internal temperature of the conventional bread maker is not sufficiently controlled.

However, according to the conventional bread maker, which ends the bread making process at the same time when the interruption of the electric power happens, even when it is all right to continue the bread making process, because the power-interruption time is short, the bread making process is ended. Thus, a user has to do it all over again.

### SUMMARY OF THE INVENTION

An aspect of the present invention provides a bread maker and a control method thereof, in which when power supply is resumed after the power-interruption time excessively passes, bread-making process is ended and a mixing bag is easily removed, and if not, the making-bread process is continuously proceeded.

According to an embodiment of the present invention, a bread maker to perform a bread making process, comprises a main body forming an oven compartment; upper and lower kneading drums spaced apart from each other inside the oven compartment, each kneading drum having a holding part holding opposite ends of a mixing bag filled with dough; a drum driving part rotating the kneading drums in clockwise and counterclockwise directions to knead the dough contained in the mixing bag; an auxiliary power supply to supply power when power supply of a primary power supply is cut off; a rotation sensing part sensing rotation position of the kneading drums; and a controller which receives power from the auxiliary power supply, measures a time interval from interruption to resumption of the power supply, determines whether the measured time exceeds a predetermined limit of power-interruption time, and ends the bread making process when the measured time exceeds the predetermined limit of power-interruption time.

In an aspect of the invention, the controller controls the drum driving part to be rotated so that the mixing bag is removed from the holding part of the lower kneading drum on the basis of the rotation position detected by the rotation sensing part when the measured time exceeds the predetermined limit of power-interruption time.

In an aspect of the invention, the controller controls rotation times of the kneading drums on the basis of the rotation position sensed by the rotation sensing part.

In an aspect of the invention, the controller controls the drum driving part so that the upper kneading drum is rotated opposite to a wound direction of the mixing bag on the upper kneading drum after the mixing bag is removed from the lower kneading drum.

In an aspect of the invention, the controller controls the rotation times of the kneading drums so that the upper kneading drum is rotated to a position in which the mixing bag was first held.

In an aspect of the invention, the bread maker further comprises a displayer, which displays that the bread-making process is ended because the measured time exceeds the predetermined limit of the power-interruption time.

In an aspect of the invention, the controller controls an interrupted bread making process to be continued when the measured time is within the predetermined limit of the power-interruption time.

According to another embodiment of the present invention, a method of controlling a bread maker, during a bread making process having an oven compartment, a pair of kneading drums spaced apart from each other inside the oven compartment with each kneading drum having a holding part holding opposite ends of a mixing bag filled with dough, and a drum driving part rotating the kneading drums to knead the dough contained in the mixing bag, comprises: detecting a rotation position of the kneading drum; determining whether a measured time exceeds a predetermined limit of power-interruption time by measuring a time from the interruption of power supply to resumption of the power supply; ending a bread making process when the measured time exceeds the predetermined limit of power-interruption time; and rotating the kneading drums so that the mixing bag is removed from the holding part of the lower kneading drum on the basis of the detected rotation positions of the kneading drum.

In an aspect of the invention, the method further comprises rotating the upper kneading drum opposite to a wound direction of the mixing bag on the upper kneading drum after the mixing bag is removed from the lower kneading drum.

In an aspect of the invention, the rotating the upper kneading drum comprises controlling rotation times of the kneading drums so that the upper kneading drum is rotated to a position in which the mixing bag was first held.

In an aspect of the invention, the method further comprises displaying that the bread making process is ended because the measured time exceeds the predetermined limit of the power-interruption time.

In an aspect of the invention, the method further comprises continuing an interrupted bread making process when the measured time is within the predetermined limit of the power-interruption time.

Additional and/or other aspects and advantages of the invention will be set forth in part in the description that follows, and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompany drawings, of which:

FIG. 1 is a perspective view of a bread maker according to an embodiment of the present invention;

FIG. 2 is a cut-away perspective view of an electric component compartment of the bread maker in FIG. 1;

FIG. 3 is a control block diagram of the bread maker in FIG. 1; and

FIG. 4 is a control flowchart of the bread maker according to another embodiment of the present invention; and

FIG. 5 is a view of a mixing bag.

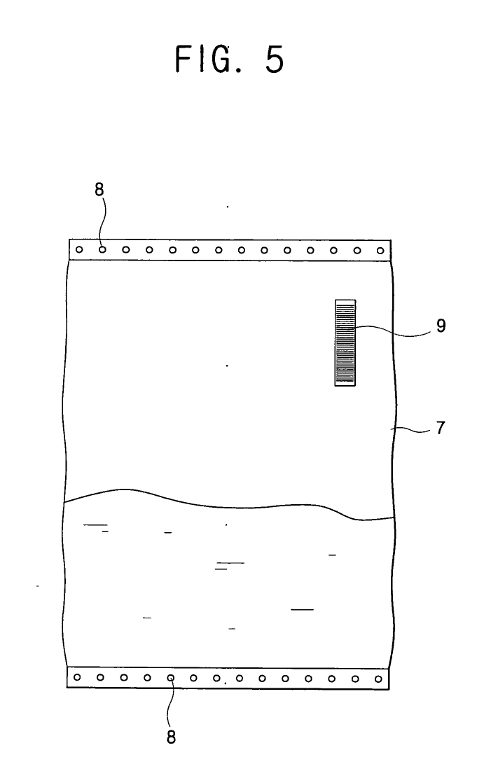

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

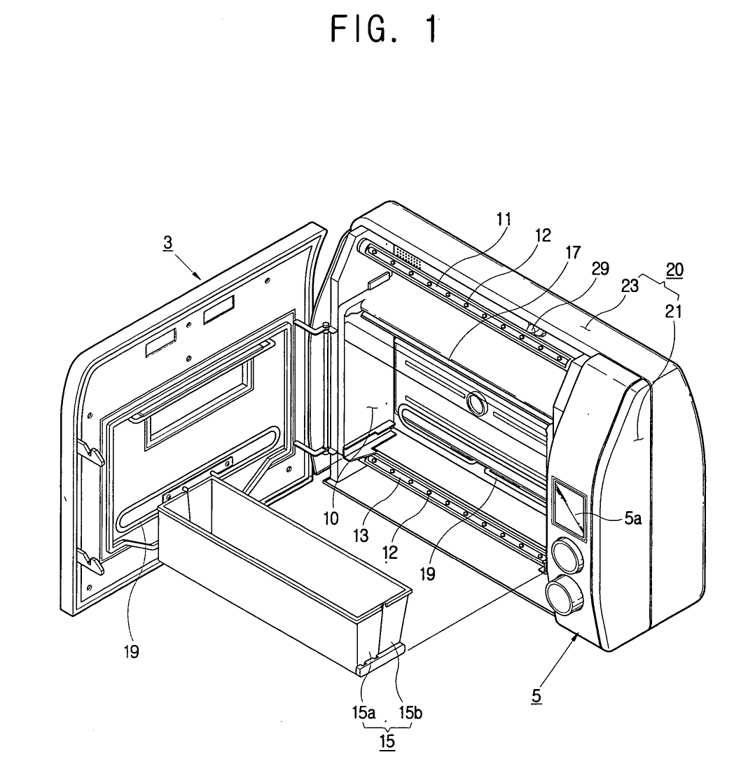

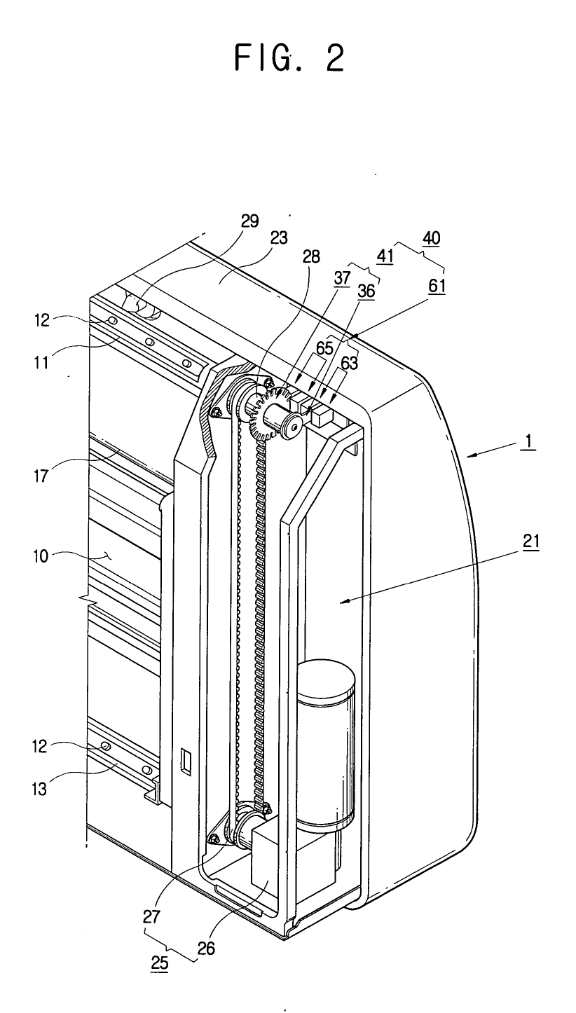

FIG. 1 is a perspective view of a bread maker according to an embodiment of the present invention, and FIG. 2 is a cut-away perspective view of an electric component compartment of the bread maker in FIG. 1. As shown in FIGS. 1 and 2, the bread maker according to an embodiment of the present invention includes a main body 1 divided into an oven compartment 10 and an electric component compartment 20, a door 3 in the front of the main body 1 to open and close a front opening of the oven compartment 10, and a control panel 5 in the front of the main body 1 to allow a user to control the bread maker and to know the status of the bread maker.

In the control panel 5, a displayer 5a is provided, which displays how far bread making process is progressed, for example, kneading and kneading time, baking and baking time, completion of the making bread, and so on, by using pictures and letters.

The displayer 5a displays information visually, and may also notify the information auditorily, for example, by using a recoded sound, or a buzzer.

Inside the oven compartment 10, upper and lower kneading drums 11 and 13 are provided in parallel and reciprocally rotate, onto which opposite ends of a mixing bag 7 filled with raw materials (ingredients) to make bread are attached and wound via winding holes 5. In a lower part of the oven compartment 10, a baking tray 15, which contains the dough to be used in a baking process, is provided between the upper and lower kneading drums 11 and 13.

The baking tray 15 includes first and second trays 15a and 15b having “L”-shaped cross sections symmetrical to one another. The first and second trays 15a and 15b combine to form a box having a top opening. In an upper part of the oven compartment 10, a pair of squeezing members 17 between the upper kneading drum 11 and the baking tray 15 prevents the dough kneaded in the mixing bag 7 from moving beyond the baking tray 15 toward the upper kneading drum 11.

At upper and lower parts of the inside walls of the oven compartment 10 and the door 3, heaters 19 to heat the inside of the oven compartment 10 are provided.

The electric component compartment 20 includes a first component compartment 21 beside the oven compartment 10 and a second component compartment 23 behind the oven compartment 10. A drum driving part 25 to rotate the upper and lower kneading drums 11 and 13 in clockwise and counterclockwise directions is included inside the first component compartment 21. A bar code scanner 29 that reads a bar code 9 printed on, or applied to, the mixing bag 7, which is wound on the upper and lower kneading drums 11 and 13 is included inside the second component compartment 23.

The drum driving part 25 includes a motor 26 rotating the lower kneading drum 13, and a belt 27 transmitting a rotary movement of the lower kneading drum 13 to a rotation shaft 28 of the upper kneading drum 11. The bar code scanner 29 is able to move near to, and distantly from, an outer circumference of the upper kneading drum 11.

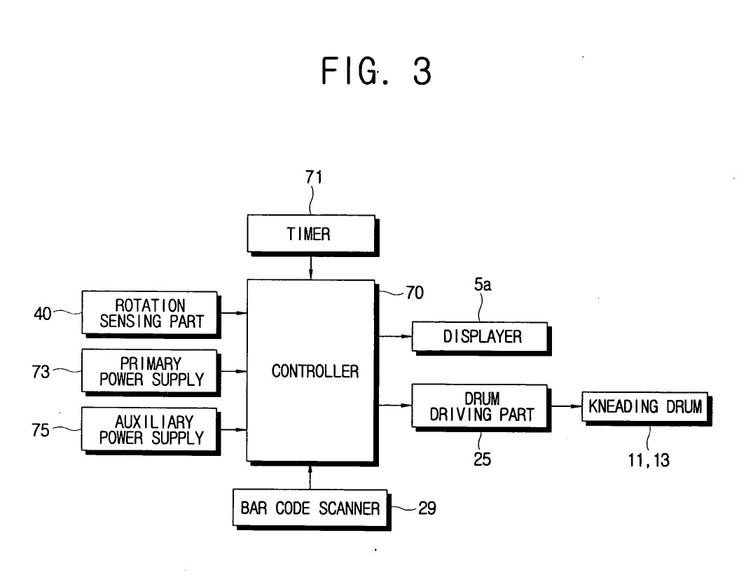

The bread maker according to an embodiment of the present invention comprises a rotation sensing part 40 detecting one or more rotation positions of at least one of a pair of kneading drums 11 and 13, a timer 71 (see FIG. 3) measuring a time interval, and a controller 70 (to be described later). The controller 70 controls the drum driving part 25 so that the mixing bag is removed from the lower kneading drum 13 on the basis of rotation position signals of the pair of kneading drums 11 and 13 detected by the rotation sensing part 40 and ends the bread making process when the progress time measured through the timer 71 exceeds a predetermined limit of power-interruption time.

The rotation sensing part 40 includes a disk part 41 attached to the rotation shaft 28 of the upper kneading drum 11, or the lower kneading drum 13, in an embodiment of the invention, and a rotation sensor 61 placed near the disk part 41, which outputs a pulse signal by sensing the rotation of the disk part 41.

The disk part 41 includes a first disk 36 that allows the rotation sensor 61 to sense one revolution of the upper kneading drum 11, and a second disk 37 that allows the rotation sensor 61 to sense a rotation less than one revolution of the upper kneading drum 11.

The first and second disks 36 and 37 each have a circular shape, in which the first disk 36 has one detecting projection and the second disk 37 has twenty four detecting projections, respectively.

It is understood that the rotation sensor may include a single disk having a set of projections that indicate partial rotations of the kneading drum and a single projection that indicates a full rotation of the kneading drum.

The rotation sensor 61 includes a first disk sensor 63 sensing the projection of the first disk 36 and outputting one pulse signal per revolution of the upper kneading drum 11. The rotation sensor 61 also includes a second disk sensor 65 sensing the twenty-four projections of the second disk 37 and outputting twenty-four pulse signals per revolution of the upper kneading drum 11. That is, when the upper kneading drum 11 makes one revolution, the first and second disk sensors 63 and 65 output one and twenty-four pulse signals, respectively.

The pulse signals outputted from the first and second disk sensor 63 and 65 of the rotation sensor 61 are transmitted to the controller 70. The controller 70 detects the rotation position of the upper kneading drum 11 on the basis of the pulse signal outputted therefrom and controls the motor 26 of the drum driving part 25 rotating the upper and lower kneading drums 11 and 13 during kneading, to thereby accurately control a distance between upper and lower positions of the mixing bag.

For example, the controller 70 rotates the motor 26 clockwise to move the mixing bag 7 upwards until the controller 70 receives the pulse signal detected by the second disk sensor 65 ten times, the controller 70 receives the pulse signal detected by the first disk sensor 63 three times, and the controller 70 receives the pulse signal detected by the second disk sensor 65 ten times. The controller 70 then rotates the motor 26 counterclockwise to move the mixing bag 7 downwards until the controller 70 receives the pulse signal detected by the second disk sensor 65 ten times, the controller 70 receives the pulse signal detected by the first disk sensor 63 three times, and the controller 70 receives the pulse signal detected by the second disk sensor 65 ten times. In such a period, the controller 70 rotates the motor 26 clockwise and counterclockwise during a predetermined time set up in a bar code to move the mixing bag 7 upwards and downwards, thereby controlling raw materials (ingredients) in the mixing bag to be kneaded.

FIG. 3 is a block diagram of the bread maker in FIG. 1 according to an embodiment of the present invention. As shown in FIG. 3, the bread maker, according to the embodiment of the present invention, comprises a rotation sensing part 40 detecting one or more rotation positions of at least one of a pair of kneading drums 11 and 13, the timer 71 measuring the time interval, the controller 70 and the displayer 5a displaying the finishing of bread making. The controller 70 determines whether the time measured by the timer 71 exceeds a predetermined limit of power-interruption time, and ends the bread making process and controls the rotation positions of the pair of kneading drums 11 and 13 on the basis of the rotation positions thereof, detected by the rotation sensing part 40, when the progress time measured by the timer 71 exceeds a predetermined limit of power-interruption time.

The timer 71, according to the present invention, receives power from an auxiliary power supply 75, which supplies power to the controller 70 and the timer 71, and measures progress time during the power-interruption, when power supply is cut off from a primary power supply 73 owing to the power interruption. Until the power-interruption ends and power is supplied from the primary power supply 73 again, the timer 71 continuously measures the progress time. The measured time is stored in a memory, which is one part of the controller 70.

The controller 70 determines whether the measured time until power is supplied again after the power-interruption exceeds a predetermined limit of the power-interruption time previously stored in the memory of the controller 70. Herein, the predetermined limit of the power-interruption time refers to a time limit in which the qualities of completely made bread or cleanness of the bread maker are not adversely affected before the temporarily interrupted bread making process, owing to a situation in which primary power is cut-off, is completed. In an embodiment of the invention, about 15 minutes is set up as the predetermined limit of the power interruption, but alternate embodiments may require that the predetermined limit of the power interruption be longer or shorter.

Also, the controller 70 continues the temporarily interrupted bread making process when the measured time is determined to be within the predetermined limit of the power interruption. If the bread making process is set up as a reservation stand-by, a reserved bread making process proceeds without respect to whether the primary power supply is temporarily cut off once it becomes time to do reserved process.

When the measured time is determined to exceed the predetermined limit of the power interruption, the controller 70 ends the bread-making process and displays that the bread-making process is ended owing to power cut-off over the predetermined limit of the power-interruption time through the displayer 5a. The displayer 5a, which is illustrated as an LCD panel (refer to FIG. 1), may inform a user of the end of the bread making by using a buzzer or a recorded sound.

The power, which is supplied from the auxiliary power supply 75 owing to the power cut-off of the primary power supply 73, is supplied to a microprocessor (not shown) including the controller 70 and the timer 71.

Thus, when the power is supplied by the auxiliary power supply 75, the rotation sensing part 40 cannot detect the rotation position because the rotation sensing part 40 does not receive the power. Information of the last rotation position, which is detected by the rotation sensing part 40 during the bread making by means of the primary power supply 73, remains in the memory of the controller 70.

The controller 70 displays the end of the bread making process, and simultaneously controls the motor 26 to rotate the kneading drums 11 and 13 so that the mixing bag can be removed from a holder of the lower kneading drums 13, on the basis of the rotation position detected by the rotation sensing part 40.

The controller 70 may control the motor 26 to rotate the upper and lower kneading drums 11 and 13 in a reverse direction relative to a rotation direction described above so that the mixing bag can be unwound from the upper kneading drum 11.

The controller 70 controls a rotation angle and rotation times of the upper and lower kneading drums 11 and 13 through the first and the second disk sensor 63 and 65.

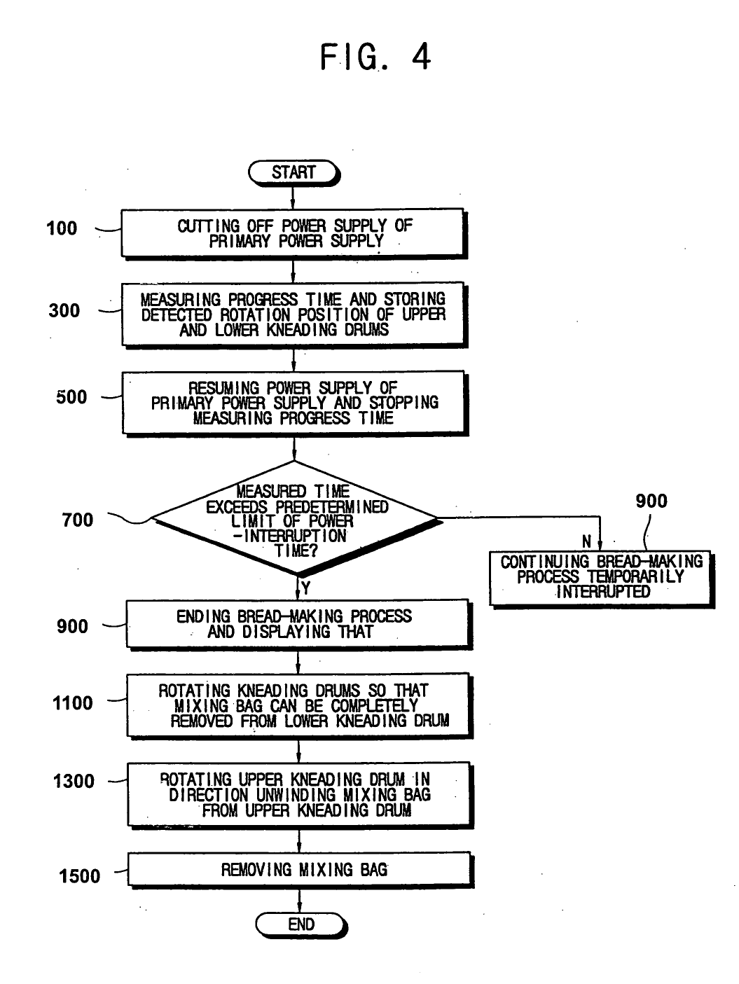

FIG. 4 is a control flowchart of the bread maker according to the embodiment of the present invention. As shown in FIG. 4, if power supply from the primary power supply 73 is cut off owing to the power interruption (100), the timer 71 receives power from the auxiliary power supply 75 and measures the progress time, and detected rotation positions of the upper and lower kneading drums 11 and 13 is stored (300). The measuring of the progress time by the timer 71 is continued until power is supplied again by the primary power supply 73.

If the supplying power by the primary power supply 73 is resumed (500), the controller 70 determines whether the measured time exceeds the predetermined limit of the power-interruption time (700).

When the measured time is within the predetermined limit of the power-interruption time, the controller 70 continues the bread-making process temporarily interrupted, which is stored in the memory thereof, on the basis of a bar code attached to the mixing bag (900).

When the measured time exceeds the predetermined limit of the power-interruption time, the controller 70 removes the bread-making process temporarily interrupted from the memory thereof and ends the bread-making process in progress. Herein, there can be displayed in the displayer 5a that the bread-making process is ended because the measured time exceeds the predetermined limit of the power-interruption time (1100).

To easily remove the wound mixing bag 7, first, at least one of the rotation positions of the pair of kneading drums, which is detected the primary power is cut off and stored in the memory of the controller 70, is read, and then the kneading drums rotate so that the mixing bag 7 can be completely removed from the lower kneading drum 13 (1300).

For example, when power interruption occurs in a state in which the mixing bag 7 is attached and wound on the upper kneading drum 11 three turns, that is, in a state in which the mixing bag 7 is wound to the utmost in the upper kneading drum 11 during a kneading process, the mixing bag 7 is controlled to be removed from the lower kneading drum 13 by rotating the upper kneading drum 11 halfway through 1 more turn in a winding direction of the mixing bag 7 on the upper kneading drum 11. Herein, measuring from the upper kneading drum 11 can be performed without respect to whether the mixing bag 7 is wound in the lower kneading drum 13.

Also, when power interruption occurs during the kneading process, the kneading drums 11 and 13 rotate to a state that the mixing bag 7 is wound into the upper kneading drum 11 to the utmost during the kneading process on the basis of the detected rotation position, and then the mixing bag 7 is controlled to be removed from the lower kneading drum 13 by rotating the upper kneading drum 11 halfway through 1 more turn in a winding direction of the mixing bag 7 on the upper kneading drum 11.

Further, after the kneading process is completed, a vacant mixing bag 7 is removed from the upper mixing drum 11 and completely wound on the lower kneading drum 13, the vacant mixing bag 7 unwinds by rotating the lower kneading drum 13 so that the vacant mixing bag 7 can be removed from the lower kneading drum 13.

When power supply is cut off while the mixing bag 7 is being wound on the lower kneading drum 13 so that the raw material completely kneaded is discharged to the baking tray 15, the mixing bag 7 may not unwind from the lower kneading drum 13 until the mixing bag 7 is completely wound in advance on the lower kneading drum 13.

When the mixing bag 7 is removed from the lower kneading drum 13, the upper kneading drum 11 rotates in a direction unwinding the mixing bag from the upper kneading drum 11 (1500).

Herein, the upper kneading drum 11 is controlled to rotate to a position in which the mixing bag 7 is held first, so that a user can easily remove the mixing bag 7 from the upper kneading drum 11.

With the above configuration, when power supply is resumed after the power-interruption time excessively passes, the bread making process is ended, the mixing bag 7 is removed from the lower kneading drum 11 and then the upper kneading drum 13 rotates in a direction unwinding the mixing bag 7, so that a user can easily remove the mixing bag 7, which is held onto the upper and the lower drums 11 and 13, therefrom.

As described above, according to the present invention, provided is a bread maker, in which when power supply is resumed after the power-interruption time excessively passes, the bread making process is ended, the mixing bag 7 is removed from the lower kneading drum 11 and then the upper kneading drum 13 rotates in a direction unwinding the mixing bag 7, so that a user can easily remove the mixing bag 7, which is held onto the upper and the lower drums 11 and 13, therefrom.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bread maker to perform a bread making process on a mixing bag filled with dough, comprising:
a main body forming an oven compartment;
a primary power supply;
upper and lower kneading drums, spaced apart from each other inside the oven compartment, to hold the mixing bag;
a driving part coupled to the primary power supply to rotate the kneading drums to knead the dough;
a controller, measuring a time interval from an interruption of the primary power supply to a resumption of the primary power supply, to determine whether the measured time exceeds a predetermined limit of power-interruption time, and to end the bread making process when the measured time exceeds the predetermined limit of power-interruption time; and
an auxiliary power supply to supply power to the controller when the primary power supply is interrupted.

2. The bread maker according to claim 1, further comprising a rotation sensing part sensing rotation position of the kneading drums, wherein the controller controls the drum driving part to be rotated so that the mixing bag is removed from the holding part of the lower kneading drum on the basis of the rotation position detected by the rotation sensing part when the measured time exceeds the predetermined limit of power-interruption time.

3. The bread maker according to claim 2, wherein the controller controls rotation times of the kneading drums on the basis of the rotation position sensed by the rotation sensing part.

4. The bread maker according to claim 3, wherein the controller controls the drum driving part so that the upper kneading drum is rotated opposite to a wound direction of the mixing bag on the upper kneading drum after the mixing bag is removed from the lower kneading drum.

5. The bread maker according to claim 4, wherein the controller controls the rotation times of the kneading drums so that the upper kneading drum is rotated to a position in which the mixing bag was first held.

6. The bread maker according to claim 1, further comprising a displayer, which displays that the bread-making process is ended because the measured time exceeds the predetermined limit of the power-interruption time.

7. The bread maker according to claim 2, further comprising a displayer, which displays that the bread-making process is ended because the measured time exceeds the predetermined limit of the power-interruption time.

8. The bread maker according to claim 3, further comprising a displayer, which displays that the bread-making process is ended because the measured time exceeds the predetermined limit of the power-interruption time.

9. The bread maker according to claim 4, further comprising a displayer, which displays that the bread-making process is ended because the measured time exceeds the predetermined limit of the power-interruption time.

10. The bread maker according to claim 5, further comprising a displayer, which displays that the bread-making process is ended because the measured time exceeds the predetermined limit of the power-interruption time.

11. The bread maker according to claim 2, wherein the controller controls an interrupted bread making process to be continued when the measured time is within the predetermined limit of the power-interruption time.

12. A method of controlling a bread maker during a bread making process having an oven compartment, a primary power supply, a pair of kneading drums spaced apart from each other inside the oven compartment with each kneading drum having a holding part holding opposite ends of a mixing bag filled with dough, a drum driving part rotating the kneading drums to knead the dough contained in the mixing bag, and an auxiliary power supply to supply power to the controller when the primary power supply is interrupted, the method comprising:
detecting a rotation position of the kneading drum;
determining whether a measured time exceeds a predetermined limit of power-interruption time by measuring a time from the interruption of the primary power supply to resumption of the power supply;
ending the bread making process when the measured time exceeds the predetermined limit of power-interruption time; and
rotating the kneading drums so that the mixing bag is removed from the holding part of the lower kneading drum on the basis of the detected rotation positions of the kneading drum.

13. The method according to claim 12, further comprising rotating the upper kneading drum opposite to a wound direction of the mixing bag on the upper kneading drum after the mixing bag is removed from the lower kneading drum.

14. The method according to claim 12, wherein the rotating the upper kneading drum comprises controlling rotation times of the kneading drums so that the upper kneading drum is rotated to a position in which the mixing bag was first held.

15. The method according to claim 12, further comprising displaying that the bread making process is ended because the measured time exceeds the predetermined limit of the power-interruption time.

16. The method according to claim 13, further comprising displaying that the bread making process is ended because the measured time exceeds the predetermined limit of the power-interruption time.

17. The method according to claim 14, further comprising displaying that the bread making process is ended because the measured time exceeds the predetermined limit of the power-interruption time.

18. The method according to claim 12, further comprising continuing an interrupted bread making process when the measured time is within the predetermined limit of the power-interruption time.

19. The bread maker according to claim 1, further comprising:
a rotation sensing part to detect a rotation position signal of the upper kneading drum; and
a timer to measure a time interval during which the primary power supply is interrupted.

20. The bread maker according to claim 19, wherein the controller controls the drum driving part to rotate the lower kneading drum on the basis of a rotation position signal detected by the rotation sensing part and ends the bread making process when the time interval measured by the timer exceeds a predetermined limit of power interruption time.

21. The bread maker according to claim 1, wherein the predetermined limit of power interruption time is a maximum time in which the bread making process is not adversely affected by the interruption of the primary power supply.

22. The bread maker according to claim 21, wherein a default value for the predetermined limit of power interruption time is 15 minutes.

23. A bread maker to perform a bread making process on a mixing bag filled with dough, comprising:
a main body forming an oven compartment in which the bread making process is carried out;
a controller, to measure an interval from an interruption of a power supply to the main body to a resumption of the power supply, to determine whether the measured time exceeds a predetermined limit of power interruption time, and to end the bread making process when the measured time exceeds the predetermined limit of power interruption time; and
an auxiliary power supply to supply power to the controller when the primary power supply is interrupted.
